(19) United States
(12) Patent Application Publication
(10) Pub. No.: US 2023/0291241 A1
(43) Pub. Date: Sep. 14, 2023

(54) Battery pack, tool system, charging system, adapter and methods using the same

(71) Applicant: Greenworks (Jiangsu) Co., Ltd., Changzhou (CN)

(72) Inventors: Xian ZHUANG, Changzhou (CN); Ming LUO, Changzhou (CN); Chuanjun LIU, Changzhou (CN); Baoan LI, Changzhou (CN); Zhiyuan LI, Changzhou (CN)

(73) Assignee: Greenworks (Jiangsu) Co., Ltd., Changzhou (CN)

(21) Appl. No.: 18/186,958

(22) Filed: Mar. 21, 2023

Related U.S. Application Data
(63) Continuation of application No. PCT/CN2021/118067, filed on Sep. 13, 2021.

(30) Foreign Application Priority Data
Sep. 25, 2020 (CN) 202011020814.3
Sep. 25, 2020 (CN) 202011020844.4
Sep. 25, 2020 (CN) 202011022566.6

(51) Int. Cl. H02J 50/10; H02J 7/00; B25F 5/02; H01M 10/46; H01M 10/44

(52) U.S. Cl. CPC H02J 50/10; H02J 7/0048; H02J 7/0031; H02J 7/0044; B25F 5/02; H01M 10/46; H01M 10/44; H01M 2220/30

(57) ABSTRACT

The disclosure provides a battery pack, a tool system, a charging system, an adapter and using methods thereof. The battery pack comprises a battery assembly, a charging assembly and a discharging assembly. The charging assembly matches the battery assembly to charge the battery assembly by an external power source. The discharging assembly matches the battery assembly to supply power to the electric equipment through the battery assembly. The discharging assembly comprises a discharging coil and a discharging integration module matched with the discharging coil, so that the battery assembly outputs electrical energy through the discharging assembly in a non-contact manner.

### TECHNICAL FIELD

The disclosure relates to a Battery pack, a tool system, a charging system, an adapter and methods using the same.

### BACKGROUND

Power tools are widely loved by users because they can effectively reduce the labor intensity of workers and improve their work efficiency. They are widely used in construction, decoration, gardens, household cleaning and other fields. For example, electric drills, electric saws, vacuum cleaners, mowers, hedge trimmers, etc. In order to make the use range of the power tools not be restricted by the mains power, the power tool is usually equipped with a battery pack so that the power tool can be used without mains power. However, conventional battery packs usually use exposed conductive terminals for discharge. Such a setting reduces the waterproof performance of battery packs and power tools. When power tools are operated in rainy, it will cause short circuit of battery packs and power tools. Secondly, as the times of plugging and unplugging the exposed conductive terminals increases, the conductive terminals of battery packs and the conductive terminals of the power tools may become loose, which will cause poor contact. Finally, the interface specifications of battery packs produced by different manufacturers are different, which reduces the versatility of battery packs. In addition, when the conductive terminal is used for high-current charging, the conductive terminal will emit a large amount of heat, which will increase temperature of power tools, thereby reducing the running performance of motors.

In view of the problems mentioned above, it is necessary to provide a battery pack, a tool system, a charging system, an adapter and methods using the same.

### SUMMARY

The disclosure provides a battery pack, a tool system, a charging system, an adapter and methods thereof. The battery pack can output electrical energy in a non-contact manner through a discharging assembly, thereby improving the waterproof performance of the battery pack, and at the same time avoiding the problem of low versatility of the battery pack due to the different interface specifications.

The disclosure provides a battery pack. The battery pack comprises a battery assembly, a charging assembly and a discharging assembly. The charging assembly is matched with the battery assembly to charge the battery assembly by an external power source. The discharging assembly is matched with the battery assembly to supply power to an electric equipment by the battery assembly. The discharging assembly comprises a discharging coil and a discharging integration module matched with the discharging coil, so that the battery assembly outputs electrical energy through the discharging assembly in a non-contact manner.

In an embodiment of the battery pack of the disclosure, the discharging integration module comprises a frequency converter and a converter, an input end of the frequency converter is connected to the battery assembly, an output end of the frequency converter is connected to the discharging coil, an input end of the converter is connected to the battery assembly, and an output end of the converter is connected to the input end of the frequency converter.

In an embodiment of the battery pack of the disclosure, the charging assembly comprises a charging coil and a charging integration module matched with the charging coil, so that the battery assembly receives electrical energy in a non-contact manner through the charging assembly, the charging integration module comprises a charging rectifier circuit and a transformer circuit, an input end of the charging rectifier circuit is connected with the charging coil, and an output end of the charging rectifier circuit is connected with the battery assembly, an input end of the transformer circuit is connected with the output end of the charging rectifier circuit, and an output end of the transformer circuit is connected with the battery assembly.

In an embodiment of the battery pack of the disclosure, the charging coil and the discharging coil are a same coil or a same group of coils, the battery pack is also provided with a mode switching button and a status indicator; when the mode switching button is in a first state, the coil matches with the charging integration module; when the mode switching button is in a second state, the coil matches with the discharging integration module; when the battery pack is in a charging mode, the status indicator is in a first state; when the battery pack is in a discharging mode, the status indicator is in a second state.

In an embodiment of the battery pack of the disclosure, the battery pack further comprises a housing, the housing comprises a top wall, a bottom wall arranged opposite to the top wall, and a side wall perpendicular to the top wall; the top wall, the bottom wall and the side wall form a receiving cavity to house the battery assembly; at least one of the top wall, the bottom wall, and the side wall is provided with at least one of the coil, an external fixing frame is arranged at a corresponding position of the housing to the coil to assist in fixing the electric equipment.

In an embodiment of the battery pack of the disclosure, the battery pack is further provided with a magnetic sheet matched with the charging coil and the discharging coil, and a current detection unit to detect current of the charging assembly or the discharging assembly.

The disclosure provides a method of using a battery pack. The battery pack comprises a battery assembly, a charging assembly, and a discharging assembly. The charging assembly comprises a charging coil and a charging integration module matched with the charging coil, so that the battery pack receives electrical energy in a non-contact manner through the charging assembly, the discharging assembly comprises a discharging coil and a discharging integration module matched with the discharging coil to output electrical energy in a non-contact manner through the discharging assembly; the method of using the battery pack comprises following operations:

S0: detecting status information of the battery pack and determining whether the battery pack is abnormal,

S1: obtaining a working mode of the battery pack,

S2: controlling the charging coil to be connected to the charging integration module or controlling the discharging coil to be connected to the discharging integration module according to working mode information.

In an embodiment of the method of using the battery pack of disclosure, the operation S0 further comprises following operations:

S01: detecting whether status information of the battery assembly is abnormal and controlling the charging assembly and the discharging assembly to be disconnected from the battery assembly if abnormal,

S02: detecting whether a temperature of the charging coil or the discharging coil is abnormal and controlling the abnormal coil to be disconnected from the corresponding integrated module if abnormal.

In an embodiment of the method of using the battery pack of disclosure, the operation S2 further comprises following operations:

S21: determining whether the working mode is a charging mode, and if yes, controlling the charging coil to be connected with the charging integration module,

S22: determining whether the working mode is a discharging mode and if yes, controlling the discharging coil to be connected with the discharging integration module.

In an embodiment of the method of using a battery pack of disclosure, the method of using the battery pack further comprises operation S3: detecting a current of the charging coil or the discharging coil, determining whether the current is within a preset interval; and if not, controlling the charging coil to be disconnected from the charging integration module or controlling the discharging coil to be disconnected from the discharging integration module.

In an embodiment of the method of using the battery pack of disclosure, the battery pack further comprises a controlling assembly to control the charging assembly and the discharging assembly, the operation S3 further comprises operation S31: determining whether a current of the charging coil or the discharging coil in a time T is less than a minimum value of a preset interval after the controlling assembly is powered on; and if yes, controlling the charging coil to be disconnected from the charging integration module, or controlling the discharging coil to be disconnected from the discharging integration module, or controlling the controlling assembly to be disconnected from power.

The disclosure further provides a tool system. The tool system comprises a battery pack and a power tool. The battery pack comprises a battery assembly, a charging assembly and a discharging assembly. The charging assembly is matched with the battery assembly to charge the battery assembly through an external power source. The discharging assembly is matched with the battery assembly to supply power to electric equipment via the battery assembly. Wherein the discharging assembly comprises a discharging coil and a discharging integration module matched with the discharging coil, so that the battery assembly outputs electrical energy in a non-contact manner through the discharging assembly. The power tool comprises a working part and a mounting part. The working part is used to perform specific operations. The mounting part is provided with at least one energy receiving assembly to receive energy wirelessly and transfer received energy to the working part. Wherein the battery pack is mounted in the mounting part, and the discharging assembly matches the energy receiving assembly, so that the battery pack is capable of wirelessly supplying power to the working part.

In an embodiment of the tool system of the disclosure, the energy receiving assembly comprises an energy receiving coil and a power rectifier circuit matched with the energy receiving coil, an input end of the power rectifier circuit is connected with the energy receiving coil, an output end of the power rectifier circuit is connected with the working part to supply power to the working part, the discharging assembly further comprises a frequency converter, an input end of the frequency converter is connected with the battery assembly of the battery pack, and an output end of the frequency converter is connected with the discharging coil.

In an embodiment of the tool system of the disclosure, the charging assembly comprises a charging coil and a wireless receiving rectifier circuit matched with the charging coil. An input end of the wireless receiving rectifier circuit is connected with the charging coil, and an output end of the wireless receiving rectifier circuit is connected with the battery assembly of the battery pack.

In an embodiment of the tool system of the disclosure, the receiving coil and the discharging coil are a same coil. The battery pack is further provided with a mode switching button. When the mode switching button is in a first stage, the coil matches the wireless receiving rectifier circuit. When the mode switching button is in a second state, the coil matches the frequency converter.

In an embodiment of the tool system of the disclosure, the mounting part is a receiving groove for housing the battery pack. The receiving groove comprises a groove bottom wall and a plurality of groove side walls. At least one of the groove bottom wall and the groove side walls is provided with an energy receiving coil. The discharging coil is arranged on a side wall of the housing of the battery pack opposite to the energy receiving coil.

In an embodiment of the tool system of the disclosure, the housing comprises a first area located inside the receiving groove and a second area located outside the receiving groove. The discharging coil is located in the first area, and the receiving coil is located in the second area.

The disclosure further provides a charging system. The charging system comprises a battery pack and a charger. The battery pack comprises a battery assembly, a charging assembly and a discharging assembly. The charging assembly is matched with the battery assembly to charge the battery assembly. The discharging assembly is matched with the battery assembly to supply power to electric equipment via the battery assembly. The discharging assembly comprises a discharging coil and a discharging integration module matched with the discharging coil, so that the battery assembly outputs electrical energy in a non-contact manner through the discharging assembly. The charger comprises a charging input and an energy transmitting assembly. The charging input is used to be connected with an external power source to obtain power from the external power source. The energy transmitting assembly comprises an energy transmitting coil and an energy transmitting integration module matched with the energy transmitting coil. One end of the energy transmitting integration module is connected with the charging input, and the other end of the energy transmitting integration module is connected with the energy transmitting coil, so that the power obtained by the charger through the charging input is transmitted to the charging assembly in the battery pack in a non-contact manner through the energy transmitting assembly.

In an embodiment of the charging system of the disclosure, the charger is provided with a charging groove to house at least part of the battery pack, the charging groove comprises a groove bottom and a groove wall surrounding the groove bottom, and the energy transmitting coil is arranged on the groove bottom or the groove wall.

The disclosure further provides an adapter which is used to be matched with a battery pack provided with a connecting interface. The adapter comprises an electrical interface and a discharging assembly. The electrical interface is used to be connected with the connecting interface to obtain the electrical energy of the battery pack. The discharging assembly comprises a discharging coil and a discharging integration module matched with the discharging coil. One end of the discharging integration module is connected with the electrical interface, and the other end of the discharging integration module is connected with the discharging coil, so that the electrical energy obtained by the adapter through the electrical interface is output in a non-contact manner through the discharging assembly.

In an embodiment of the adapter of the disclosure, the discharging integration module comprises a frequency converter and a converter, an input end of the converter is connected with the electrical interface, and an output end of the converter is connected with an input end of the frequency converter, and an output end of the frequency converter is connected with the discharging coil.

In an embodiment of the adapter of the disclosure, the adapter further comprises a charging assembly, the charging assembly comprises a charging coil and a charging integration module matched with the charging coil, one end of the charging integration module is connected with the charging coil, the other end of the charging integration module is connected with the electrical interface, so that the electrical energy received by the adapter through the charging coil is output through the electrical interface, the charging integration module comprises a charging rectifier circuit and a transformer circuit, an input end of the charging rectifier circuit is connected with the charging coil, and an output end of the charging rectifier circuit is connected with an input end of the transformer circuit, and an output end of the transformer circuit is connected with the electrical interface.

In an embodiment of the adapter of the disclosure, the discharging coil and the charging coil are a same coil, the adapter is further provided with a mode switching button and a status indicator, when the mode switching button is in a first state, the coil matches the discharging integration module, when the mode switching button is in a second state, the coil matches the charging integration module, when the discharging assembly is working, the status indicator is in a first state, and when the charging assembly is working, the status indicator is in a second state.

In an embodiment of the adapter of the disclosure, the adapter further comprises a housing, the housing comprises a top wall, a bottom wall, and a side wall between the top wall and the bottom wall, the top wall, the bottom wall and the side wall form a receiving cavity to house the discharging assembly and the charging assembly, at least one of the top wall, the bottom wall, and the side wall is provided with at least one of the charging coil or the discharging coil, an external fixing frame is arranged at a corresponding position of the housing to the discharging coil to assist in fixing the electric equipment, and the adapter is further provided with a current detection unit to detect a current of the charging assembly or the discharging assembly.

The disclosure further provided a tool system. The tool system comprises a power tool, a battery pack and an adapter. The power tool is provided with a power receiving coil and an electrical energy conversion circuit matched with the power receiving coil. An input end of the electrical energy conversion circuit is connected with the power receiving coil, and an output end of the electrical energy conversion circuit is connected with a motor of the power tool to supply power to the power tool. The battery pack is provided with a connecting interface. The adapter comprises an electrical interface and a discharging assembly. The electrical interface is used to be connected with the connecting interface to obtain the electrical energy of the battery pack. The discharging assembly comprises a discharging coil corresponding to the power receiving coil and a discharging integration module matched with the discharging coil. One end of the discharging integration module is connected with the electrical interface, and the other end of the discharging integration module is connected with the discharging coil, so that the electrical energy of a battery pack obtained by the adapter through the electrical interface is transmitted to the power tool in a non-contact manner through the discharging assembly.

In an embodiment of the tool system of the disclosure, the adapter further comprises a charging assembly, the charging assembly comprises a charging coil and a charging integration module matched with the charging coil, and one end of the charging integration module is connected with the charging coil, and the other end of the charging integration module is connected with the electrical interface.

The disclosure further provides a method of using an adapter. The adapter comprises an electrical interface, a discharging assembly, and a charging assembly, the discharging assembly and the charging assembly is provided with a shared coil, the charging assembly further comprises a charging integration module matched with the coil, so that the adapter receives electrical energy in a non-contact manner through the charging assembly, the discharging assembly further comprises a discharging integration module matched with the coil, so that electrical energy obtained by the adapter through the electrical interface is output in a non-contact manner through the discharging assembly. The method of using the adapter comprises following operations:

S1: connecting the electrical interface of the adapter with the connecting interface arranged on a peripheral device,

S2: obtaining a working mode of the adapter,

S3: controlling the coil to be connected with the charging integration module or the discharging integration module according to the working mode,

S4: detecting a current in the coil, determining whether the current is within a preset interval, and if not, controlling the coil to be disconnected from the charging integration module or the discharging integration module.

In an embodiment of the method of using the adapter of the disclosure, the peripheral device is a battery assembly provided with a peripheral communication module, the adapter is provided with a communication unit matched with the peripheral communication module, and the operation S1 further comprises following operations:

S11: obtaining status information of the battery assembly through communicating of the communication unit with the peripheral communication module, determining whether there is an abnormality, and controlling the charging integration module or the discharging integration module to be disconnected from the coil if abnormal,

S12: detecting whether the temperature of the coil is abnormal, and controlling the coil to be disconnected from the charging integration module or the discharging integration module if abnormal.

In an embodiment of the method of using the adapter of the disclosure, the operation S3 comprises following operations:

S31: determining whether the working mode is a charging mode and if yes, connecting the control coil with the charging integration module,

S32: determining whether the working mode is a discharging mode and if yes, connecting the control coil with the discharging integration module.

In an embodiment of the method of using the adapter of the disclosure, the adapter further comprises a controlling assembly to control the charging assembly and the discharging assembly, the operation S4 further comprises operation S41: determining whether the current in the coil is always less than a minimum value of a preset interval in a time T after the controlling assembly is energized, and if yes, controlling the coil to cut off the charging integration module or cut off the discharging integration module, or controlling the controlling assembly to power off.

The beneficial effects of the disclosure are that the battery pack of the disclosure can output electrical energy in a non-contact manner through the discharging assembly, thereby improving the waterproof performance of the battery pack, and at the same time, low versatility of the battery pack caused by the difference in interface specifications is avoided. The tool system of the disclosure can receive electrical energy in a non-contact manner through matching the energy receiving assembly with the wireless transmitting assembly, thereby avoiding short circuit and loosening of the conductive terminals due to the exposed conductive terminals of the conventional electric tools. The adapter of the disclosure is connected to the peripheral device, so that the peripheral device can receive electrical energy or output electrical energy in a non-contact manner through the adapter.

### BRIEF DESCRIPTION OF THE DRAWINGS

FIG. 1 is a perspective view of a battery pack according to a first embodiment of the disclosure.

FIG. 2 is an exploded view of the battery pack shown in FIG. 1.

FIG. 3 is a schematic view of matching of the battery pack in FIG. 1 with an electric equipment shown.

FIG. 4 is an exploded perspective view of the battery pack according to a second embodiment of the disclosure.

FIG. 5 is a schematic view of matching of the battery pack in FIG. 1 with a charger shown.

FIG. 6 is a cross-sectional view of FIG. 5.

FIG. 7 is a schematic block diagram of the battery pack shown in FIG. 1.

FIG. 8 is a working flowchart of the battery pack shown in FIG. 1.

FIG. 9 is a flowchart of a method of using a battery pack of the disclosure.

FIG. 10 is a perspective view of an electric tool of the disclosure.

FIG. 11 is a schematic view of a three-dimensional structure of an electric tool.

FIG. 12 is an exploded view of a battery pack.

FIG. 13 is a schematic block diagram of the battery pack shown in FIG. 12.

FIG. 14 is a working flowchart of the battery pack shown in FIG. 12.

FIG. 15 is a perspective view of a tool system of the disclosure.

FIG. 16 is a schematic view of matching of the battery pack with the charger.

FIG. 17 is a cross-sectional view of FIG. 16.

FIG. 18 is a perspective view of an adapter of the disclosure.

FIG. 19 is a perspective view of the adapter shown in FIG. 18 from another angle.

FIG. 20 is a schematic view of an internal structure of the adapter shown in FIG. 18.

FIG. 21 is a schematic view of matching of the battery pack, the power tool, and the adapter.

FIG. 22 is a schematic block diagram of the adapter shown in FIG. 18.

FIG. 24 is a flowchart of a method of using an adapter of the disclosure.

### DETAILED DESCRIPTION

In order to make the objectives, technical solutions and advantages of the disclosure clearer, the disclosure will be described in detail below with reference to drawings and specific embodiments.

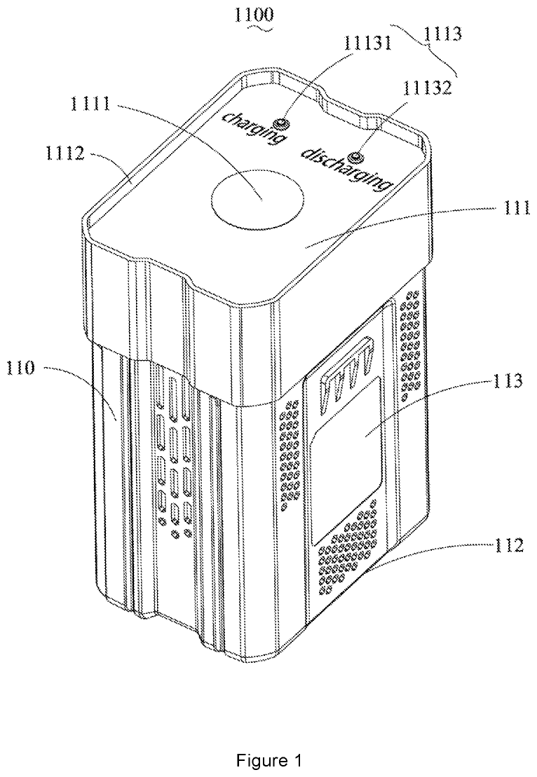

Please refer to FIG. 1 through FIG. 9, the disclosure provides a battery pack. The battery pack includes a battery assembly, a charging assembly, and a discharging assembly. The battery assembly can be a single battery, or a battery group composed of a plurality of single batteries connected in series or in parallel. The charging assembly is matched with the battery assembly, so that an external power source can charge the battery assembly through the charging assembly. The discharging assembly is matched with the battery assembly, so that the battery assembly can supply power to electric equipment through the discharging assembly. At least one of the charging assembly and the discharging assembly includes a coil and an integrated module matched with the coil, so that the battery assembly can receive electrical energy through the charging assembly in a non-contact manner or output electrical energy through the discharging assembly in a non-contact manner. The non-contact manner means that the charging assembly and the external power source are capable of achieving power transmitting without electrically connection through conductive terminals, and the discharging assembly and the electric equipment are capable of achieving power transmitting without electrically connection through conductive terminals. The description will be given below in conjunction with specific embodiments.

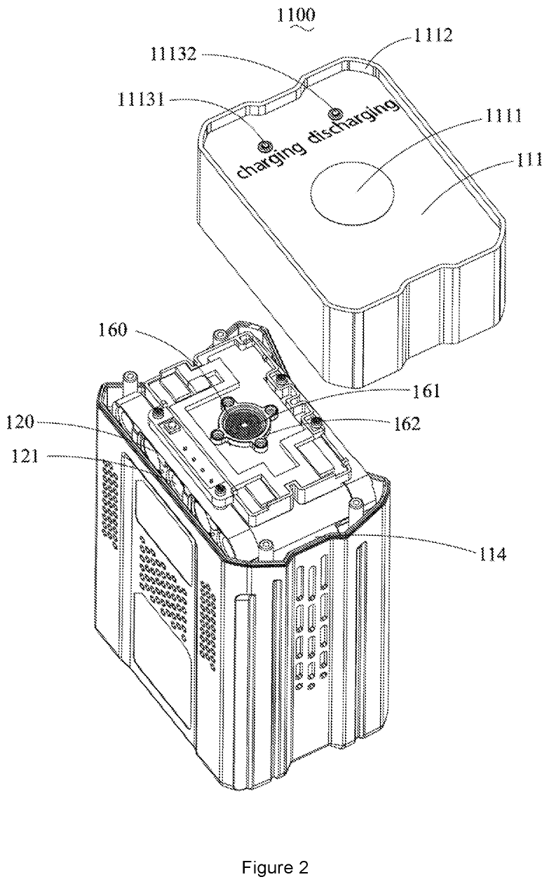

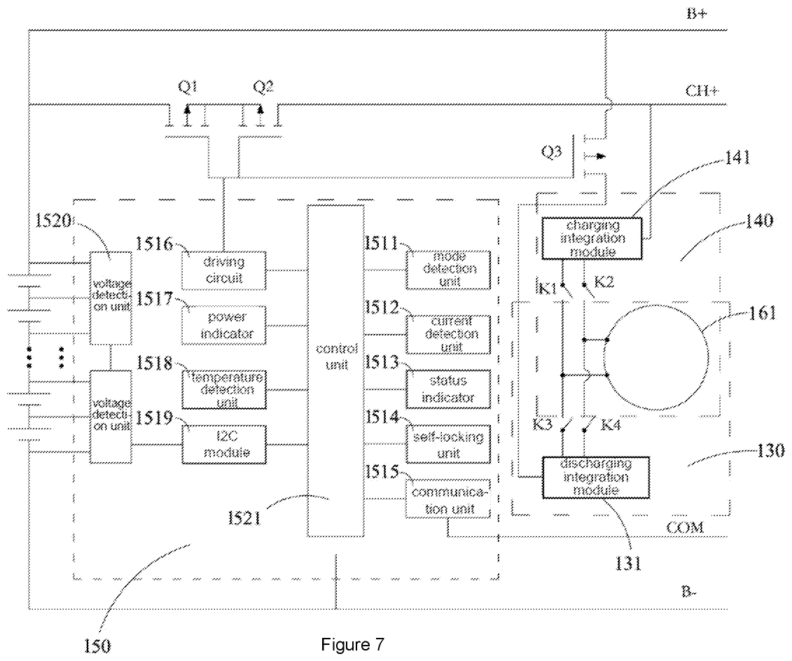

Please refer to FIG. 1, FIG. 2 and FIG. 7, the disclosure provides a battery pack 1100 which includes a housing 110, a battery assembly 120, a discharging assembly 130, a charging assembly 140 and a controlling assembly 150. The housing 110 includes a top wall 111, a bottom wall 112 opposite to the top wall 111, and a side wall 113 perpendicular to the top wall 111. The top wall 111, the bottom wall 112 and the side wall 113 form a receiving cavity 114 for housing the battery assembly 120, the discharging assembly 130, the charging assembly 140 and the controlling assembly 150. The top wall 111 is provided with a coil marking area 1111, an external fixing frame 1112 and a mode switching button 1113. The coil marking area 1111 is used to indicate the position of the coil, which is convenient for the user to make a coil of the electric equipment or a charger directly face the coil. The external fixing frame 1112 is used to assist in fixing electric equipment, such as mobile phones, pads, smart watches, and so on. Of course, in other embodiments, the external fixing frame 1112 may also not be provided. The mode switching button 1113 is used to switch the battery pack 1100 between a charging mode and a discharging mode. When the mode switching button 1113 is in a first state, the battery pack 1100 is in the charging mode. When the mode switching button 1113 is in a second state, the battery pack 1100 is in the discharging mode. In this embodiment, the mode switching button 1113 includes a charging button 11131 and a discharging button 11132. When the charging button 11131 is pressed, which means, in the first state, the battery pack 1100 is in the charging mode. When the discharging button 11132 is pressed, which means, in the second state, the battery pack 1100 is in the discharging mode. Of course, it is understandable that in other embodiments, the functions of the charging button 11131 and the discharging button 11132 may also be replaced by one mode button. For example, when the mode button is pressed, which means, in the first state, the battery pack 1100 is in the charging mode. When the mode button is reset, which mean: in the second state, the battery pack 1100 is in the discharging mode. In practical applications, in order to prevent the user from pressing the mode switching button 1113 by mistake, the battery pack 1100 is also capable of provided with a foolproof structure. For example: the battery pack 1100 may be provided with a housing groove, and the mode switching button 1113 is arranged in the housing groove. When the electric equipment is attached to the battery pack 1100, the mode switching button 1113 is in a released state (which means, the second state), and the battery pack 1100 is in the discharging mode at this time. When the charging equipment with the charging coil is attached to the battery pack 1100, a resisting arm arranged on the charging equipment extends into the housing groove to press the mode switching button 1113, and the battery pack 1100 is in the charging mode at this time.

Please refer to FIG. 2, the battery assembly 120 can be a single battery 121 or a battery group composed of a plurality of single batteries 121. Please refer to FIG. 7 and FIG. 2, the discharging assembly 130 includes a discharging coil and a discharging integration module 131 matched with the discharging coil. The discharging integration module 131 includes a converter, a frequency converter, and so on. An input end of the converter is connected with the battery assembly 120, and an output end of the converter is connected with an input end of the frequency converter, so as to convert an output voltage of the battery assembly 120 into a voltage suitable for the frequency converter. An output end of the frequency converter is connected with the discharging coil. With this arrangement, the battery assembly 120 is capable of outputting electrical energy to the outside through the discharging coil in a non-contact manner. The charging assembly 140 includes a charging coil and a charging integration module 141 matched with the charging coil. The charging integration module 141 includes a charging rectifier circuit, a transformer circuit, and so on. An input end of the charging rectifier circuit is connected with the charging coil, an output end of the charging rectifier circuit is connected with an input end of the transformer circuit, and an output end the transformer circuit is connected with the battery assembly 120. With this arrangement, the battery assembly 120 can obtain electrical energy through the charging coil. In this embodiment, the discharging coil and the charging coil share a coil assembly 160. The coil assembly 160 is arranged on the side of the top wall 111 facing a receiving cavity 1102. The coil assembly 160 includes a coil 161, a magnetic sheet (not shown) matched with the coil 161, and a fixing plate 162 which fixes the coil 160 and the magnetic sheet on the top wall 111. When the mode switching button 1113 is in the first state, the controlling assembly 150 controls the charging integration module 141 to connect with the coil 161. When the mode switching button 1113 is in the second state, the controlling assembly 150 controls the discharging integration module 131 to connect with the coil 161.

Please refer to FIG. 7, the controlling assembly 150 includes a mode detection unit 1511, a current detection unit 1512, a status indicator 1513, a self-locking unit 1514, a communication unit 1515, a driving circuit 1516, a power indicator 1517, a temperature detection unit 1518, an I2C module 1519, a voltage detection unit 1520, and a control unit 1521. The mode detection unit 1511 is used to detect a state of the mode switching button 1113 and transmit state information of the mode switching button 1113 to the control unit 1521. The current detection unit 1512 collects currents of the coil 161. When a current value is within a preset interval, the charging or the discharging is normal. When the current value is greater than a maximum value of the preset interval, the charging or the discharging is abnormal, at this time, the control unit 1521 controls switching transistor Q1 and Q2 to turn off or a switching transistor Q3 to turn off through the driving circuit 1516, so as to disconnect the battery assembly 120 from the discharging assembly 130 or the charging assembly 140. When the current value is less than a minimum value of the preset interval, the battery assembly 120 is fully charged or the battery assembly 120 is fully discharged to the outside, or the battery assembly 120 is in an under-voltage state. The status indicator 1513 is used to display that the battery assembly 120 is in a charging mode or a discharging mode. When the battery pack 1100 is in the charging mode, the status indicator 1513 is in the first state. When the battery pack 1100 is in the discharging mode, the status indicator 1513 is in the second state. The control unit 1521 can be powered on and locked itself through the self-locking unit 1514. In this embodiment, the control unit 1521 is a single-chip microcomputer. The communication unit 1515 is used to communicate with the electric equipment or the charger. In this embodiment, the communication unit 1515 is a COM communication module. Of course, it can be understood that in other embodiments, the communication unit 1515 may also be a wireless communication unit such as Bluetooth or zigbee. The driving circuit 1516 drives the switching transistors Q1, Q2, Q3 to work or stop working under the control of the control unit 1521. The power indicator 1517 is used to display the power of the battery assembly 20. The temperature detection unit 1518 is used to detect the temperature of the battery assembly 120 and the coil 161. When the temperature of the battery assembly 120 or the temperature of the coil 161 is abnormal, the temperature detection unit 1518 will transmit an alarm signal. At the same time the control unit 1521 controls the driving circuit 1516 to work, so as to disconnect the battery assembly 120 from the discharging assembly 130 and the charging assembly 140. The voltage detection unit 1520 is used to detect a voltage of the single battery 121. When the voltage of the single battery 121 is abnormal, the voltage detection unit 1520 will emits an alarm signal. At the same time the control unit 1521 controls the driving circuit 1516 to work so as to disconnect the battery assembly 120 from the discharging assembly 130 or the charging assembly 140. The I2C module is connected with the voltage detection unit 1520 and the control unit 1521 to facilitate communication between the voltage detection unit 1520 and the control unit 1521.

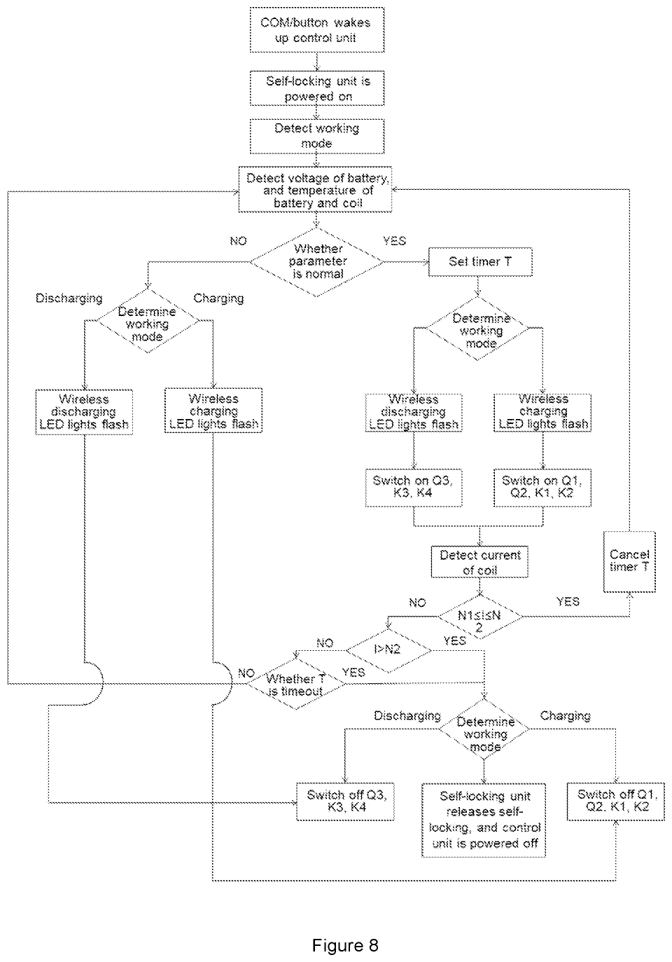

FIG. 8 shows a working flowchart of the battery pack 1100 of the disclosure. When using the battery pack 1100 of the disclosure, the control unit 1521 is awakened through a button or the communication unit 1515 firstly, and then the self-locking unit 1514 is powered on and self-locked. Next, the mode detection unit 1511 detects working mode, and the temperature detection unit 1518 detects a voltage and a temperature of the battery assembly 120 and a temperature of the coil 161. When the voltage or the temperature of the battery assembly 120 or the temperature of the coil 161 is abnormal, the control unit 1521 controls the corresponding status indicator 1513 to flash according to the working mode, and turns off the switches Q3, K3, K4 or the switches Q1, Q2, K1, K2. And finally the self-locking unit 1514 releases the self-locking. The control unit 1521 is powered off. When the voltage and the temperature of the battery assembly 120 and the temperature of the coil 161 are normal, the control unit 1521 sets a timer T, controls the corresponding status indicator 1513 to be normally turned on according to the working mode, and then turns on the switches Q3, K3, K4 or the switches Q1, Q2, K1, K2 to make the discharging assembly 130 or the charging assembly 140 work normally. Next, the current detection unit 1512 detects a current of the coil 161 and determines whether the current value is within a preset interval [N1, N2]. If the current value is within the preset interval, the control unit 1521 cancels the timer T. If the current value is greater than N2, the control unit 1521 cuts off the discharging assembly 130 or the charging assembly 140 according to the working mode, then the self-locking unit 1514 releases the self-locking, and the control unit 1521 is powered off. When the current value is less than N1, the control unit 1521 determines whether the timer T exceeds a preset time. When the timer T exceeds the preset time T, it indicates that the battery pack 1100 is not connected with the electric equipment or the charger to perform a discharging or a charging function.

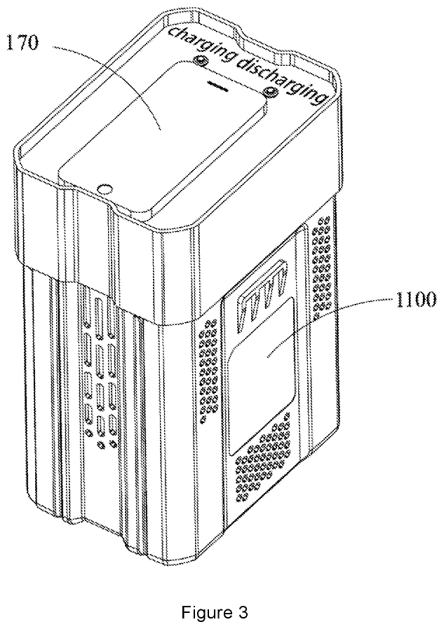

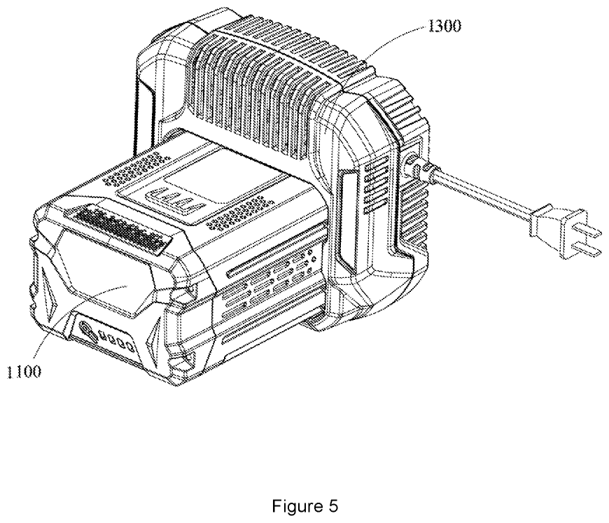

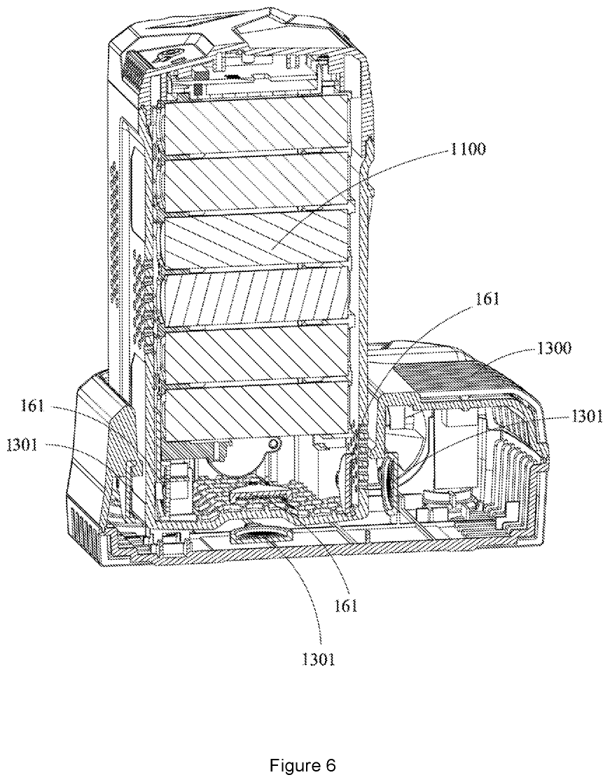

Compared with the conventional art, the battery pack 1100 of the disclosure realizes discharging or charging in a non-contact manner through the discharging assembly 130 and the charging assembly 140 provided with the coil 161, thereby avoiding the problem of conventional battery packs 1100 caused by exposed conductive terminals. For example, conductive terminals are prone to rust and short circuits due to rain, etc. At the same time, the electric equipment provided with a power receiving coil can be directly used in conjunction with the coil 161 of the battery pack 1100 without the problem that the battery pack can not be used due to different interface standards. For example, as shown in FIG. 3, when in use, as long as the electric equipment 170 provided with the power receiving coil is attached to the top wall 111, it is capable of being used. The electric equipment 170 may be a tablet computer, a mobile phone, a smart watch, a power bank, and so on. As shown in FIG. 5 and FIG. 6, when power of battery pack 1100 is insufficient, the battery pack 1100 can be charged through matching the charger 1300 provided with a power transmitting coil 1301 with the coil 161.

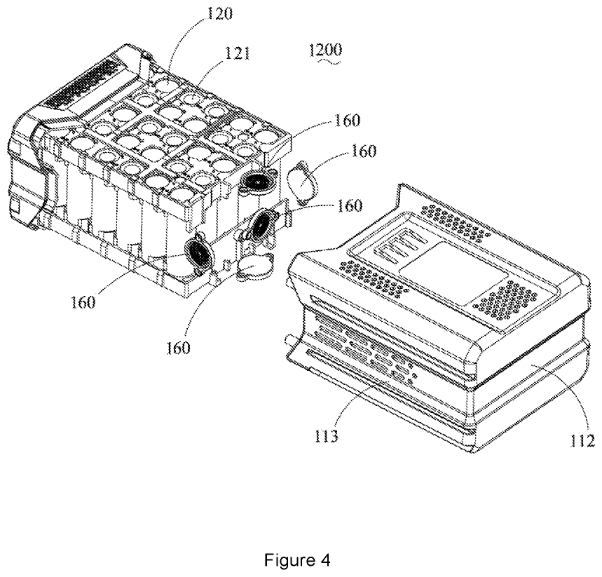

FIG. 4 shows a battery pack 1200 according to another embodiment of the disclosure. A structure of the battery pack 1200 is substantially the same as a structure of the battery pack 1100, and the difference is that the battery pack 1200 has a plurality of coil assemblies 160. In this embodiment, the number of the coil assemblies 160 is five, and the five coil assemblies are fixed on the bottom wall 112 and the four side walls 113 respectively. The five coil assemblies 160 are arranged in parallel to increase an output current of the battery pack 1200. Of course, in other embodiments, the five coil assemblies 160 may also be arranged in series to increase the output voltage of the battery pack 1200. In this embodiment, only one coil assembly 160 is arranged on each of the bottom wall 112 and the side walls 113. However, it can be understood that in other embodiments, a plurality of the coil assemblies 160 may also be arranged on the bottom wall 112 and the side wall 113.

In the battery packs 1100 and 1200, the discharging assembly 130 and the charging assembly 140 share the coil assembly 160. However, in other embodiments, the discharging assembly 130 and the charging assembly 140 can also be configured not to share the coil assembly 160, which means that the discharging assembly 130 includes a separate discharging coil, and the charging assembly 140 includes a separate charging coil.

Although the battery packs 1100, 1200 of the disclosure are not provided with conductive terminals for charging or discharging, in other embodiments, the battery pack 1100/1200 may also be provided with conductive terminals to improve versatilities of the battery packs 1100, 1200. Of course, it can be understood that in practical applications, the charging assembly 140 provided with a coil may be combined with a discharging assembly provided with conductive terminals, or the discharging assembly 130 provided with a coil may be combined with a charging assembly provided with conductive terminals.

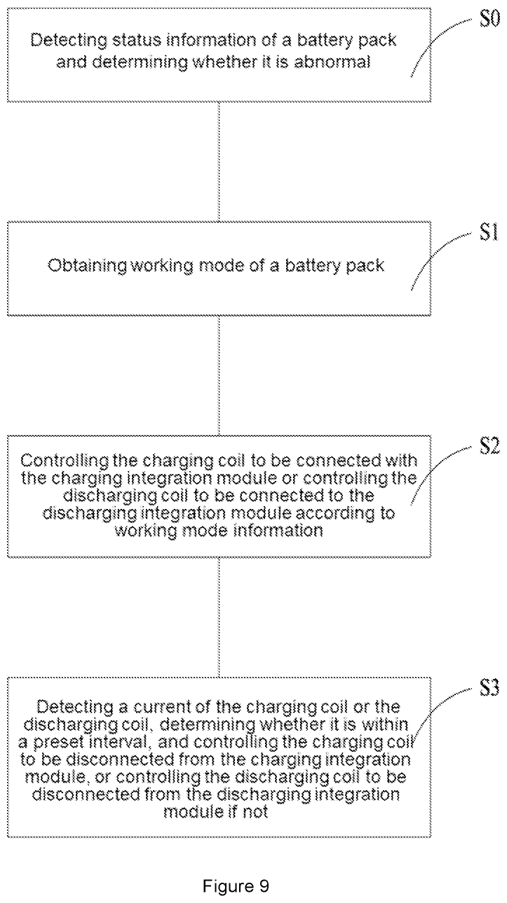

Please refer to FIG. 9, the disclosure further provides a method of using the battery pack 1100/1200, the method includes following operations:

S0: detecting the status information of the battery pack 1100/1200 and determining whether the status information is abnormal.

S1: obtaining working mode of the battery pack 1100/1200.

In practical applications, the operations S0 and S1 can be set in no particular order, which means that the operation S0 may executed first, and then the operation S1 is executed; the operation S1 may executed first, and then the operation S0 is executed; it may be also possible to execute the operations S0 and S1 at the same time.

S2: controlling the charging coil to be connected with the charging integration module 141 or controlling the discharging coil to be connected with the discharging integration module 131 according to working mode information.

S3: detecting the current in the charging coil or the current in the discharging coil, and determining whether the current is within a preset interval. If not, the charging coil will be controlled to be disconnected from the charging integration module 141, or the discharging coil will be controlled to be disconnected from the discharging integration module 131. Preferably, determining whether a current of the charging coil or the discharging coil is always less than a minimum value of the preset interval in a time T after the controlling assembly 150 is powered on. If so, the charging coil and the charging integration module 141 are controlled to be cut off, or the discharging coil and the discharging integration module 131 are controlled to be cut off, or the controlling assembly 150 will be controlled to be power off.

Preferably, the operation S0 further includes the following operations:

S01: detecting whether status information of the battery assembly 120 is abnormal. If abnormal, the charging assembly 140 and the discharging assembly 130 are controlled to be disconnected from the battery assembly 120.

S02: detecting whether temperature of the charging coil or the discharging coil is abnormal. If abnormal, the charging coil will be controlled to be disconnected from the charging integration module 141, or the discharging coil will be controlled to be disconnected from the discharging integration module 131.

Preferably, the operation S2 further includes the following operations:

S21: determining whether the working mode is the charging mode. If so, the charging coil will be controlled to be connected with the charging integration module 141.

S22: determining whether the working mode is the discharging mode. If so, the discharging coil will be controlled to be connected with the discharging integration module 131.

Preferably, the charging coil and the discharging coil are the same coil or the same group of coils 161.

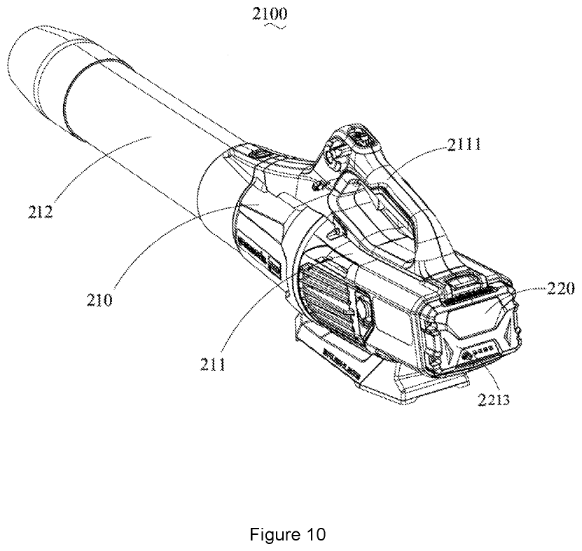

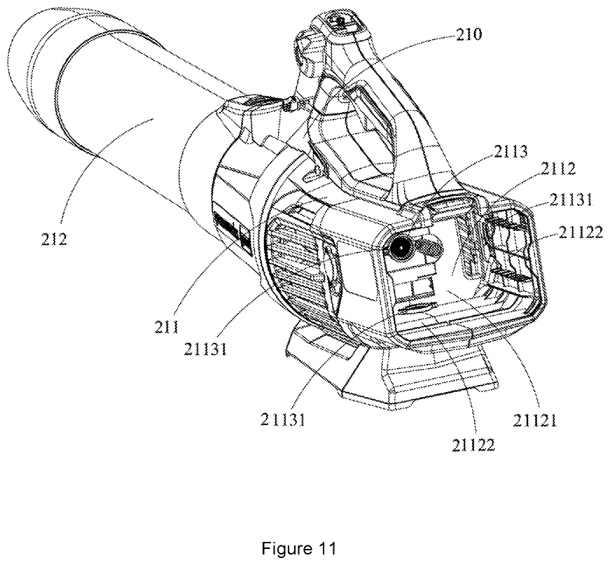

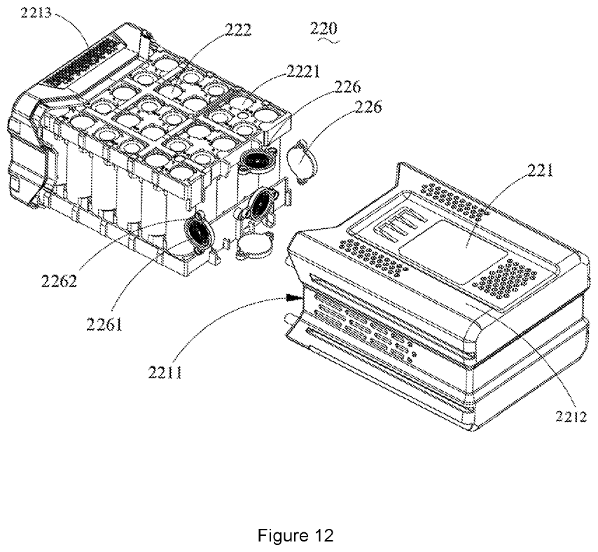

Please refer to FIG. 10, FIG. 11 and FIG. 12 for details. The disclosure also provides a tool system 2100. The tool system 2100 includes an operating mechanism 210 and a battery pack 220 matched with the operating mechanism 210.

Please refer to FIG. 10 and FIG. 11, the operating mechanism 210 includes a housing 211 and a working part. The working part is used to perform specific operations, and includes a driving motor (not shown) housed in the housing 211 and an operating assembly 212 mounted at the front end of the housing 211. The housing 211 includes a handle 2111 located at the top of the housing 211, a mounting part 2112 located at the rear end of the housing 2111, and an energy receiving assembly 2113 arranged on the mounting part 2112. In this embodiment, the mounting part 2112 is a receiving groove for housing the battery pack 220, and an end of the receiving groove away from the driving motor is communicated with the outside. The receiving groove 2112 includes a groove bottom wall 21121 and a plurality of groove side walls 21122. The energy receiving assembly 2113 is used to be matched with the battery pack 220 to obtain power from the battery pack 220 and transmit the power to the operating mechanism 210. The energy receiving assembly 2113 includes an energy receiving coil 21131 and a power rectifier circuit (not shown) matched with the energy receiving coil 21131. The energy receiving coil 21131 is arranged on at least one of the groove bottom wall 21121 and the groove side walls 21122. In this embodiment, each of the groove bottom wall 21121 and the groove side walls 21122 is provided with one energy receiving coil 21131. However, in other embodiments, the position and number of the energy receiving coils 21131 are may be set as required. For example, one energy receiving coil 21131 may be arranged on the groove bottom wall 21121, and one energy receiving coil 21131 may be arranged on each groove side wall 21122. It is also possible to only arrange one energy receiving coil 21131 on each of the groove side walls 21122, or only arrange one energy receiving coil 21131 on the groove bottom wall 21121, or only arrange the energy receiving coil or coils 21131 on the one groove side wall or more groove side walls 21122. A plurality of the energy receiving coils 21131 may be arranged in parallel to increase an input current. Of course, multiple energy receiving coils 21131 may also be arranged in series to increase an input voltage. An input end of the power rectifier circuit is connected with the energy receiving coil 21131, and an output end of the power rectifier circuit is connected with the driving motor of the operating mechanism 210 to supply power to the driving motor. The operating assembly 212 is used to perform the function of the operating mechanism 210. In this embodiment, the operating assembly 212 is a blowing assembly. However, in other embodiments, the operation assembly 212 may also be other mechanisms, such as a chain saw, a dust suction assembly, a trimmer head, a mowing assembly, etc., which is not limited in the disclosure.

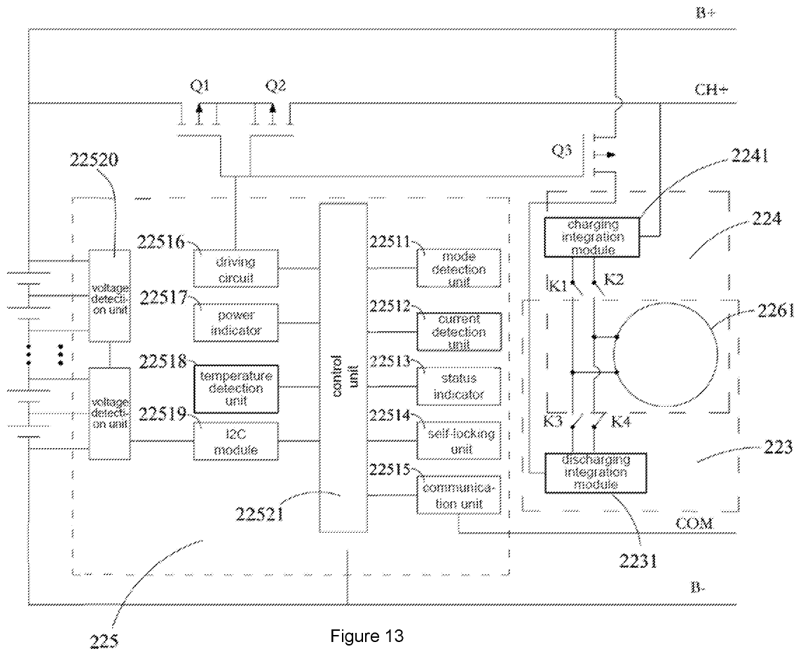

Please refer to FIG. 12 and FIG. 13, the battery pack 220 includes a housing 221, a battery assembly 222, a wireless transmitting assembly 223 (ie, a discharging assembly), a wireless receiving assembly 224, and a controlling assembly 225. The housing 221 is provided with a receiving cavity 2211 and a mode switching button (not shown). The receiving cavity 2211 is used for housing the battery assembly 222, the wireless transmitting assembly 223, the wireless receiving assembly 224 and the controlling assembly 225. The mode switching button is used to switch the battery pack 220 between a charging mode and a discharging mode. When the mode switching button is in the first state, the battery pack 220 is in the charging mode. When the mode switching button is in the second state, the battery pack 220 is in the discharging mode. In this embodiment, the mode switching button includes a charging button and a discharging button. When the charging button is pressed, which means the first state, the battery pack 220 is in the charging mode. When the discharging button is pressed, which means the second state, the battery pack 220 is in the discharging mode. Of course, it is understandable that in other embodiments, the functions of the charging button and the discharging button may also be performed by one mode switching button. For example, when the mode switching button is pressed, which means the first state, the battery pack 220 is in the charging mode. When the mode switching button is reset, which means the second state, the battery pack 220 is in the discharging mode. In practical applications, in order to prevent the user from pressing the mode switching button by mistake, the battery pack 220 may also be provided with a fool-proof structure. For example, the battery pack 220 may be provided with a housing groove, and the mode switching button is arranged in the housing groove. When the battery pack 220 is inserted into the receiving groove 2112, the mode switching button is in a released state (which means the second state), and the battery pack 220 is in the discharging mode at this time. When the charging equipment with the energy transmitting coil is attached against the battery pack 220, the resisting arm arranged on the charging equipment extends into the housing groove to press the mode switching button, and the battery pack 220 is in the charging mode at this time.

Please refer to FIG. 12, the battery assembly 222 may be a single battery 2221 or a battery group including a plurality of single batteries 2221. Please refer to FIG. 13 and FIG. 12, the wireless transmitting assembly 223 matches the energy receiving assembly 2113 so that the operating mechanism 210 obtains power of the battery assembly 222 in a non-contact manner. Since the wireless transmitting assembly 223 and the energy receiving assembly 2113 transmit power in a non-contact manner, it effectively avoids short circuit, loosening and oxidation of the conductive terminals when used in rainy days due to the exposed conductive terminals of the conventional electric tools, thereby effectively improving users' experience. The wireless transmitting assembly 223 includes a wireless transmitting coil (ie, a discharging coil) coupled with the energy receiving coil 21131 and a discharging integration module 2231 matched with the wireless transmitting coil. The discharging integration module 2231 includes a converter, a frequency converter, and so on. An input end of the converter is connected to the battery assembly 222, and an output end of the converter is connected with an input end of the frequency converter, so as to convert an output voltage of the battery assembly 222 into a voltage suitable for the frequency converter. The output terminal of the frequency converter is connected with the wireless transmitting coil. With this arrangement, the battery assembly 222 can output electrical energy to the outside through the wireless transmitting coil. The wireless receiving assembly 224 is used to match a charger provided with an energy transmitting coil, so that the charger can charge the battery pack 220 in a non-contact manner. Since the battery pack 220 obtains external power in a non-contact manner, it effectively avoids a short circuit due to an exposed charging input of the battery pack when the conventional electric tool is used in rainy days. The wireless receiving assembly 224 includes a wireless receiving coil and a charging integration module 2241 matched with the wireless receiving coil. The charging integration module 2241 includes a wireless receiving rectifier circuit, a transformer circuit, and so on. An input end of the wireless receiving rectifier circuit is connected to the wireless receiving coil, an output end of the wireless receiving rectifier circuit is connected with an input end of the transformer circuit, and an output end the transformer circuit is connected to the battery assembly 222. With this arrangement, the battery assembly 222 can obtain electrical energy through the wireless receiving coil. In this embodiment, the wireless transmitting coil and the wireless receiving coil share a coil assembly 226. The coil assembly 226 is arranged on a side wall of the housing 221 opposite to the energy receiving coil 21131. The coil assembly 226 includes a coil 2261, a magnetic sheet (not shown) matched with the coil 2261, and a fixing plate 2262 which fixes the coil 2261 and the magnetic sheet on the housing 221. When the mode switching button is in the first state, the controlling assembly 225 controls the charging integration module 2241 to be connected with the coil 2261. When the mode switching button is in the second state, the controlling assembly 225 controls the discharging integration module 2231 to be connected with the coil 2261.

Please refer to FIG. 13, the controlling assembly 225 includes a mode detection unit 22511, a current detection unit 22512, a status indicator 22513, a self-locking unit 22514, a communication unit 22515, a driving circuit 22516, a power indicator 22517, a temperature detection unit 22518, an I2C module 22519, a voltage detection unit 22520, and a control unit 22521. The mode detection unit 22511 is used to detect the state of the mode switching button and transmit state information of the mode switching button to the control unit 22521. The current detection unit 22512 collects a current of the coil 2261. When a current value is within the preset interval, it indicates that the charging or discharging is normal. When the current value is greater than a maximum value of the preset interval, it indicates that the charging or discharging is abnormal. At this time, the control unit 22521 controls the switching transistors Q1 and Q2 to turn off or the switching transistor Q3 to turn off through the driving circuit 22516, so as to disconnect the battery assembly 222 from the wireless transmitting assembly 223 or the wireless receiving assembly 224. When the current value is less than a minimum value of the preset interval, it indicates that the battery assembly 222 is fully charged or the battery assembly 222 is fully discharged to the outside or the battery assembly 222 is in an under-voltage state. The status indicator 22513 is used to display that the battery assembly 222 is in a charging mode or a discharging mode. When the battery pack 220 is in the charging mode, the status indicator 22513 is in the first state. When the battery pack 220 is in the discharging mode, the status indicator 22513 is in the second state. The control unit 22521 is powered on and self-locked through the self-locking unit 22514. In this embodiment, the control unit 22521 is an arithmetic processing device such as a central processing unit (CPU) or a micro processing unit (MPU), and a storage device such as a random access memory (RAM) or a read only memory (ROM). The communication unit 22515 is used to communicate with the operating mechanism 210 or the charger. In this embodiment, the communication unit 22515 is a COM communication module. Of course, it can be understood that in other embodiments, the communication unit 22515 may also be a wireless communication unit such as Bluetooth or zigbee. The driving circuit 22516 drives the switching transistors Q1, Q2, and Q3 to work or stop working under the control of the control unit 22521. The power indicator 22517 is used to display power of the battery assembly 222. The temperature detection unit 22518 is used to detect temperatures of the battery assembly 222 and the coil 2261. When the temperature of the battery assembly 222 or the temperature of the coil 2261 is abnormal, the temperature detection unit 22518 transmits an alarm signal, and the control unit 22521 controls the driving circuit 22516 to work at the same time, so as to disconnect the battery assembly 222 from the wireless transmitting assembly 223 and the wireless receiving assembly 224. The voltage detection unit 22520 is used to detect a voltage of the single battery 2221. When the voltage of the single battery 2221 is abnormal, the voltage detection unit 22520 will transmit an alarm signal, and the control unit 22521 will control the driving circuit 22516 to work at the same time, so as to disconnect the battery assembly 222 from the wireless transmitting assembly 223 and the wireless receiving assembly 224. The I2C module is connected with the voltage detection unit 22520 and the control unit 22521 to facilitate communication between the voltage detection unit 22520 and the control unit 22521.

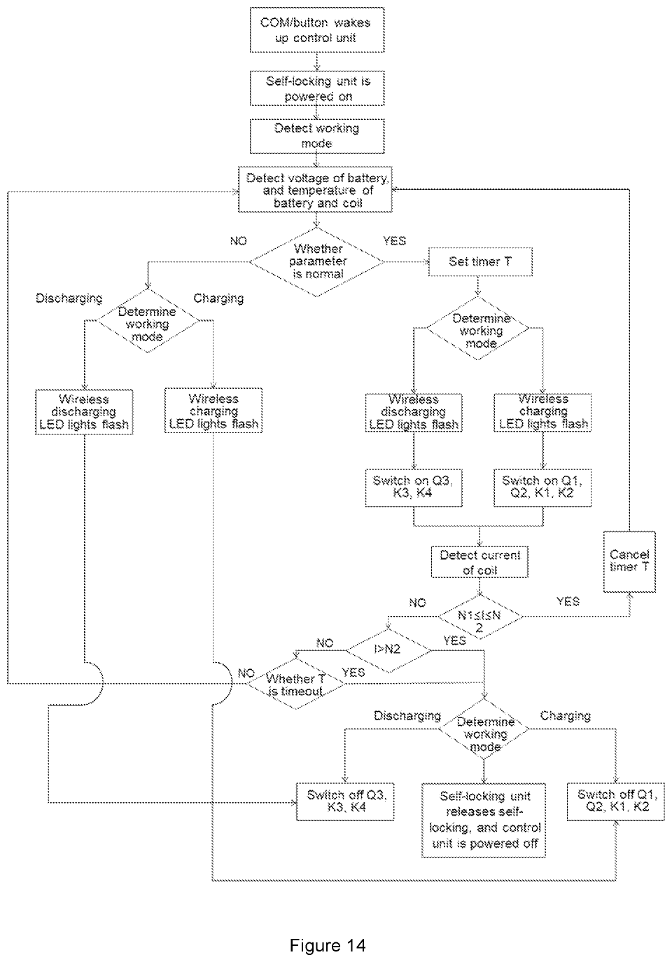

FIG. 14 shows a working flowchart of the battery pack 220. When the battery pack 220 is used, the control unit 22521 will be first awakened through a button or the communication unit 22515, and then the self-locking unit 22514 will be powered on and self-locked. Next, the mode detection unit 22511 detects working mode, and the temperature detection unit 22518 detects a voltage and a temperature of the battery assembly 222 and a temperature of the detection coil 2261. When the voltage and the temperature of the battery assembly 222 and the temperature of the coil 2261 are abnormal, the control unit 22521 will control the corresponding status indicator 22513 to flash according to the working mode, and turn off the switches Q3, K3, K4 or switches Q1, Q2, K1, K2. Finally the self-locking unit 22514 releases the self-locking, and the control unit 22521 is powered off. When the voltage and the temperature of the battery assembly 222 and the temperature of the coil 2261 are normal, the control unit 22521 will set a timer T, and control the corresponding status indicator 22513 to be normally turned on according to the working mode. Then switches Q3, K3, K4 or switches Q1, Q2, K1, K2 will be turned on to make the wireless transmitting assembly 223 or the wireless receiving assembly 224 work normally. Next, the current detection unit 22512 detects the current of the coil 2261 and determines whether the current value is within a preset interval [N1, N2]. If the current value is within the preset interval, the control unit 22521 will cancel the timer T. If the current value is greater than N2, the control unit 22521 will cut off the wireless transmitting assembly 223 or the wireless receiving assembly 224 according to the working mode, then the self-locking unit 22514 will release self-locking, and the control unit 22521 will be powered off. When the current value is less than N1, the control unit 22521 will determine whether the timer T exceeds a preset time. When the timer T exceeds the preset time T, it indicates that the battery pack 220 is not connected with the electric equipment or the charger to perform the discharging or charging function.

Compared with the conventional art, the operating mechanism 210 and the battery pack 220 of the tool system 2100 of the disclosure realize a non-contact power transmission through matching the energy receiving assembly 2113 with the wireless transmitting assembly 223. This avoids the short circuit in rainy days due to the exposed conductive terminals, and also avoids the loosing of the conductive terminals due to repeated plugging, thereby effectively improving users' experience. Secondly, since the battery pack 220 is matched with a charger provided with an energy transmitting coil through the wireless receiving assembly 224, battery pack 220 can be charged in a non-contact manner, which further improves the waterproof performance of the tool system 2100. Finally, since the operating mechanism 210 and the battery pack 220 disperse input or output through the multiple energy receiving coils 21131, the wireless transmitting coils, and the wireless receiving coils, the problem is avoided that excessively high temperature of the energy receiving assembly 2113, the wireless transmitting assembly 223, and the wireless receiving assembly 224 under the condition of relatively high power.

In this embodiment, the wireless transmitting assembly 223 and the wireless receiving assembly 224 share the coil 2261. With this arrangement, when charging the battery pack 220, the battery pack 220 is needed to be taken out from the receiving groove 2112 of the operating mechanism 210, which causes inconvenience. Preferably, the wireless transmitting coil of the wireless transmitting assembly 223 and the wireless receiving coil of the wireless receiving assembly 224 are independent of each other. Please refer to FIG. 10 and FIG. 12, the housing 221 includes a first area 2212 located inside the receiving groove 2112 and a second area 2213 located outside the receiving groove 2112. The wireless transmitting coil is arranged in the first area 2212, and the wireless receiving coil is arranged in the second area 2213. With this arrangement, the battery pack 220 can be charged without being taken out from the receiving groove 2112, thereby effectively improving users' experience. For example, when the operating mechanism 210 is a smart mower or a vacuum cleaner, and when the power of the battery pack 220 is insufficient, the mower and the vacuum cleaner can walk to the charging shed by themselves, and pair the wireless receiving assembly 224 of the battery pack 220 to the energy transmitting coil of the charging shed for charging. Since the battery pack 220 does not need to be plugged and unplugged in the charging shed, the difficulty of automatic charging of the smart mower and the smart vacuum cleaner is effectively reduced. At the same time, with this arrangement, problems such as short-circuit of the smart mower and the smart vacuum cleaner in a rainy day due to an open-air charging shed may be avoided, thereby effectively improving the safety of the smart mower and the smart vacuum cleaner. In addition, since the charging shed does not need to be provided with exposed conductive terminals, the safety of the charging shed may be improved.

Of course, it can be understood that, in this embodiment, the operating mechanism 210 and the battery pack 220 transmit electrical energy in a non-contact manner through the energy receiving assembly 2113 and the wireless transmitting assembly 223. However, in practical applications, the energy receiving assembly 2113 and the wireless transmitting assembly 223 can be configured to transmit electrical energy in a contact manner through the conductive terminals. Preferably, the energy receiving assembly 2113 and the wireless transmitting assembly 223 are sealed as a whole to prevent rainwater from entering. At this time, the battery pack 220 is charged in a non-contact manner through the wireless receiving assembly 224.

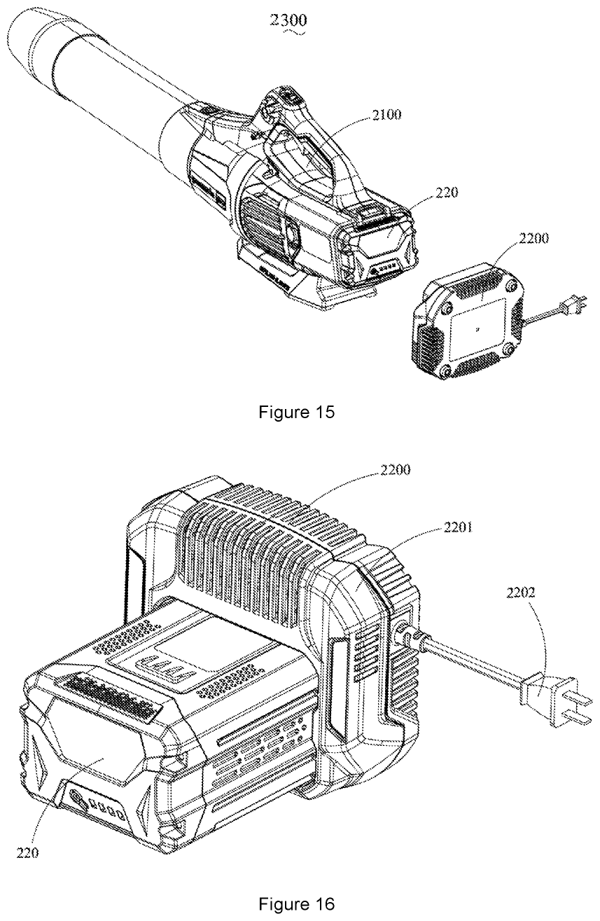

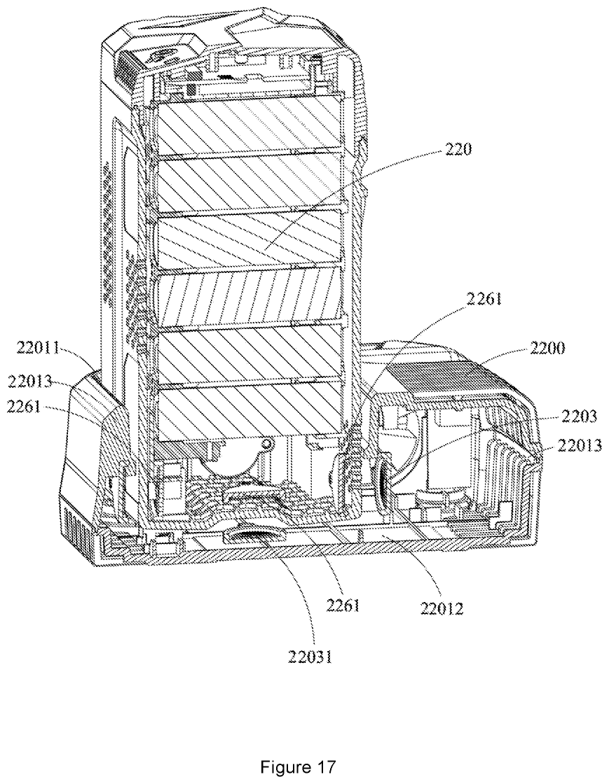

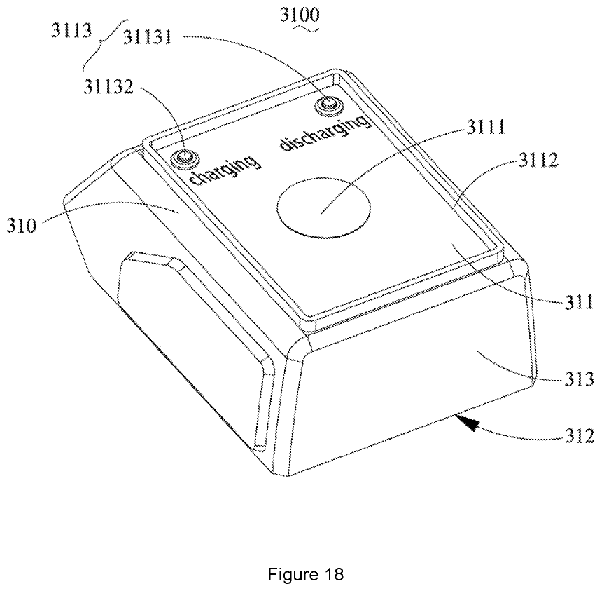

Please refer to FIG. 15, FIG. 16 and FIG. 17, the disclosure further provides a charging system 2300, including the tool system 2100 and a charger 2200 for charging the battery pack 220 of the tool system 2100. The charger 2200 includes a charging shell 2201, a charging input 2202, and an energy transmitting assembly 2203 arranged in the charging shell 2201. The charging shell 2201 is provided with a charging groove 22011 matched with the battery pack 2201. The charging groove 22011 includes a groove bottom 22012 and a groove wall 22013 surrounding the groove bottom 22012. The charging input 2202 is used to connect with an external power source to obtain power from the external power source. The energy transmitting assembly 2203 includes an energy transmitting coil 22031 and an energy transmitting integration module matched with the energy transmitting coil 22031. The energy transmitting coil 22031 is arranged on at least one of the groove bottom 22012 and the groove wall 22013. Preferably, a position and a number of the energy transmitting coil 22031 match a position and a number of the wireless receiving coil arranged on the battery pack 220. One end of the energy transmitting integration module is connected with the charging input 2202, and the other end is connected with the energy transmitting coil 22031, so that the power obtained by the charger 2200 through the charging input 2202 is transmitted to the battery pack 220 of the tool system 2100 in a non-contact manner through the energy transmitting assembly 2203.

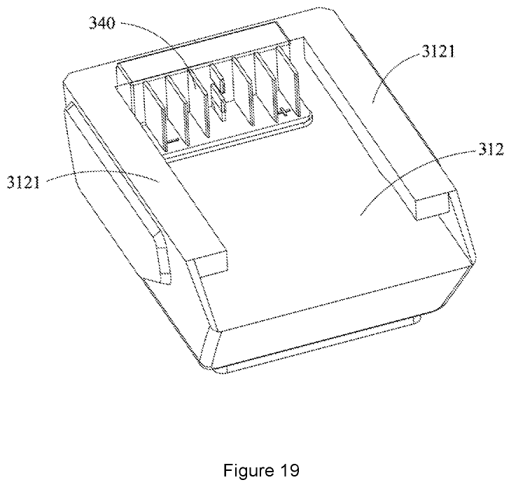

Further, please refer to FIG. 18 through FIG. 24, in order to solve the problem that a charger provided with a wireless energy transmitting module cannot charge a battery pack on the market that is not provided with a wireless energy receiving module and results in a limitation of the application range of a charger provided with a wireless energy transmitting module, the disclosure further provides an adapter, the adapter includes an electrical interface and a power transmitting assembly matched with the electrical interface. The electrical interface is used for electrical connection with a connecting interface provided on a first peripheral device. The power transmitting assembly includes a coil and a transmitting integration module matched with the coil. One end of the transmitting integration module is connected with the coil, and the other end thereof is connected with the electrical interface, so that the power obtained by the electrical interface is output in a non-contact manner through the power transmitting assembly or the power obtained by the coil in a non-contact manner is output to the first peripheral device through the electrical interface. The description will be given below in conjunction with specific embodiments.

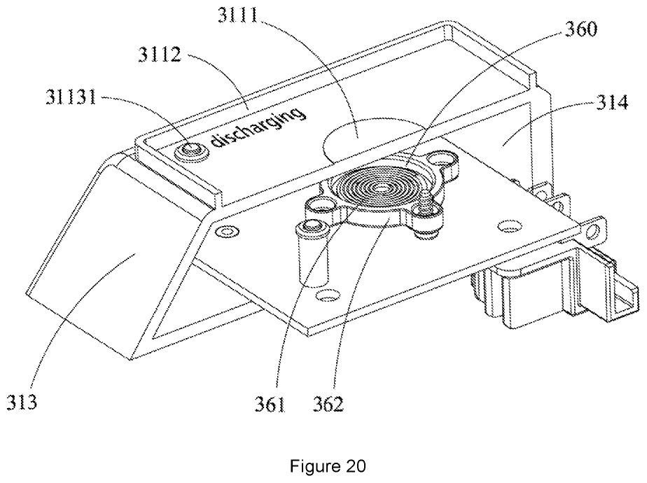

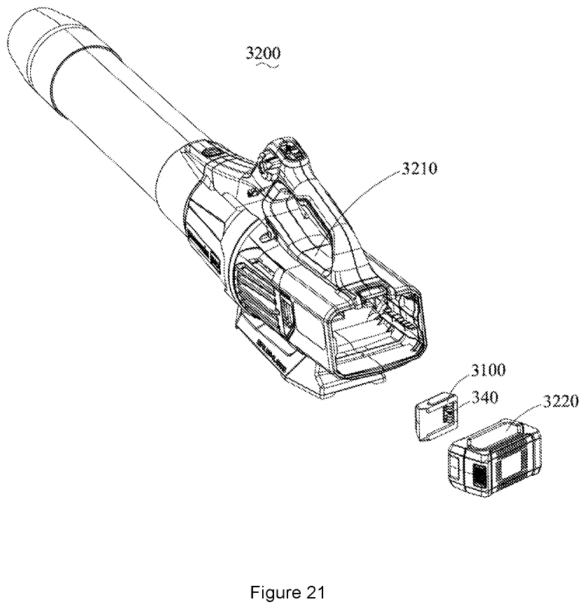

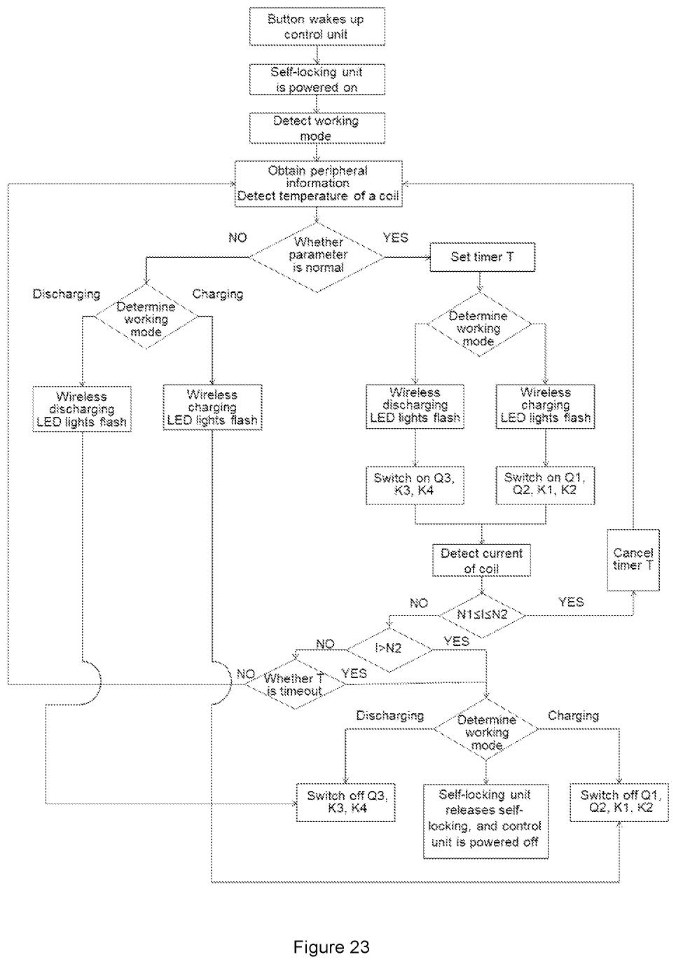

Please refer to FIG. 18, FIG. 19, FIG. 20, and FIG. 22, the disclosure provides an adapter 3100; the adapter includes a housing 310, a power transmitting assembly, an electrical interface 340, and a controlling assembly 350. The power transmitting assembly is housed in the housing 310 and includes a discharging assembly 320 and a charging assembly 330. Although in this embodiment, the power transmitting assembly includes the charging assembly 330, it is understood that in other embodiments, the power transmitting assembly may not include the charging assembly 330.

Please refer to FIGS. 18, 19 and 20, the housing 310 includes a top wall 311, a bottom wall 312 arranged opposite to the top wall 311, and a side wall 313 located between the top wall 311 and the bottom wall 312. The top wall 311, the bottom wall 312 and the side wall 313 jointly form a receiving cavity 314 for housing the discharging assembly 320, the charging assembly 330 and the controlling assembly 350. The top wall 311 is provided with a coil marking area 3111, an external fixing frame 3112 and a mode switching button 3113. The coil marking area 3111 is used to indicate the position of the coil, which is convenient for the user to directly face the second peripheral device to the coil. The second peripheral device is provided with a peripheral coil matched with the coil, and the second peripheral device may be a charger, an electric tool, a power bank, a battery pack, a tablet computer, a mobile phone, a smart watch, and so on. The external fixing frame 3112 is used to assist in fixing the second peripheral device. Of course, in other embodiments, the external fixing frame 3112 may not be provided. The mode switching button 3113 is used to switch the adapter 3100 between a charging mode and a discharging mode. When the mode switching button 3113 is in the first state, the adapter 3100 is in the discharging mode. When the mode switching button 3113 is in the second state, the adapter 3100 is in the charging mode. In this embodiment, the mode switching button 3113 includes a discharging button 31131 and a charging button 31132. When the discharging button 31131 is pressed, which means the first state, the adapter 3100 is in the discharging mode. When the charging button 31132 is pressed, which means the second state, the adapter 3100 is in the charging mode. Of course, it can be understood that in other embodiments, the functions of the discharging button 31131 and the charging button 31132 may be served by one mode button. For example, when the mode button is pressed, which means the first state, the adapter 3100 is in the discharging mode. When the mode button is reset, which means the second state, the adapter 3100 is in the charging mode. In practical applications, in order to prevent the user from pressing the mode switching button 3113 by mistake, the adapter 3100 can be provided with a foolproof structure. For example, when the electric device is attached to the adapter 3100 and the mode switching button 3113 is in a pressed state (which means the first state), the adapter 3100 is in the discharging mode at this time. When the charging device with the charging coil is attached to the adapter 3100, the mode switching button extends into the housing groove arranged on the charging device, so that the mode switching button is in a released state (which means the second state), and the adapter 3100 is in the charging mode at this time. The bottom wall 312 is provided with a guiding part 3121 to guide the adapter 3100 to match a power supply device (for example, a battery pack, a power bank, etc.). In this embodiment, the guiding part 3121 is a sliding groove, but in other embodiments, the guiding part 3121 may be a sliding rail. Otherwise, in other embodiments, the guiding part 3121 may not be provided.

Please refer to FIG. 20 and FIG. 22, the discharging assembly 320 includes a discharging coil and a discharging integration module 321 matched with the discharging coil. The discharging integration module 321 includes a converter, a frequency converter, and so on. An input end of the converter is connected with the electrical interface 340, and an output end of the converter is connected with an input end of the frequency converter to convert the voltage obtained by the electrical interface 340 from the battery pack into a voltage suitable for the frequency converter. An output end of the frequency converter is connected with the discharging coil. With this arrangement, the battery pack plugged into the adapter 3100 can output electrical energy through the discharging assembly 320 in a non-contact manner. The charging assembly 330 includes a charging coil and a charging integration module 331 matched with the charging coil. The charging integration module 331 includes a charging rectifier circuit, a transformer circuit, and so on. An input end of the charging rectifier circuit is connected with the charging coil, an output end of the charging rectifier circuit is connected with an input end of the transformer circuit, and an output end of the transformer circuit is connected with the electrical interface 340. With this arrangement, the battery pack and the electric tool plugged into the adapter 3100 can obtain electrical energy through the charging assembly 330 in a non-contact manner. The non-contact manner means that the electrical energy transmission is capable of being realized without the electrical connection between the discharging assembly 320 and the electric equipment through the conductive terminal, and the electrical energy transmission is capable of being realized without the electrical connection between the charging assembly 320 and an external battery pack through the conductive terminal. In this embodiment, the discharging coil and the charging coil share the coil assembly 360. The coil assembly 360 is arranged on the side of the top wall 311 facing a receiving cavity 314. The coil assembly 360 includes a coil 361, a magnetic sheet (not shown) matched with the coil 361, and a fixing plate 362 which fixes the coil 361 and the magnetic sheet on the top wall 311. When the mode switching button 3113 is in the first state, the controlling assembly 350 controls the discharging integration module 321 to be connected with the coil 361. When the mode switching button 3113 is in the second state, the controlling assembly 350 controls the charging integration module 331 to be connected with the coil 361. The electrical interface 340 is used for connecting with battery packs, power banks, mains supply and other battery packs, or with electric tools. The battery pack, power bank, mains supply, electric tool, etc. are provided with a connecting interface that matches the electrical interface 340. When the electrical interface 340 is connected with the battery pack or the power bank, the battery pack or the power bank can obtain external electrical energy through the electric interface 340 in a non-contact manner, or output electrical energy in a non-contact manner. When the electrical interface 340 is connected with a battery pack 3220 provided with no wireless energy receiving module, the electric tool can obtain energy from battery pack 3220 through the adapter 3100 in a non-contact manner. In this embodiment, only the top wall 311 is provided with the coil 361, but in other embodiments, it may be arranged that at least one of the top wall 311, the bottom wall 312, and the side wall 313 is provided with at least one of the coils 361. When the number of the coils 361 is greater than or equal to 2, the coils 361 may be set in series or in parallel.

Please refer to FIG. 22, the controlling assembly 350 includes a driving circuit 351, a self-locking unit 352, a status indicator 353, a temperature detection unit 354, a mode detection unit 355, a current detection unit 356, a communication unit 357 and a control unit 358. The driving circuit 351 drives the switching transistors Q1 and Q2 to be turned on or off under the control of the control unit 358. The self-locking unit 352 is used to perform power-on and self-locking. The status indicator 353 is used to display that the adapter 3100 is in a discharging mode or a charging mode. When the adapter 3100 is in the discharging mode, the status indicator 353 is in the first state. When the adapter 3100 is in the charging mode, the status indicator 353 is in the second state. The temperature detection unit 354 is used to detect the temperature of the coil 361. When the temperature of the coil 361 is abnormal, the temperature detection unit 354 will transmit an alarm signal, and the control unit 358 will control the drive circuit 351 to work, so as to disconnect the electrical interface 340 from the discharging assembly 320 or charging assembly 330. The mode detection unit 355 is used to detect a state of the mode switching button 3113 and transmit state information of the mode switching button 3113 to the control unit 358. The current detection unit 356 collects a current of the coil 361. When the current value is within the preset interval, it indicates that the charging or discharging is normal. When the current value is greater than the maximum value of the preset interval, it indicates that the charging or discharging is abnormal; at this time, the control unit 358 controls driving circuit 351 to work, and controls the switching transistor Q1 or the switching transistor Q2 to turn off, so as to disconnect the electrical interface 340 from the discharging assembly 320 or the charging assembly 330. When the current value is less than the minimum value of the preset interval, it indicates that the battery pack, power bank, etc. connected with the adapter 3100 is fully charged or discharged, or that the electric tool connected with the adapter 3100 stops working. The communication unit 357 is used to communicate with peripheral device connected with the adapter 3100. In this embodiment, the communication unit 357 is a COM communication module. Of course, it can be understood that in other embodiments, the communication unit 357 may be a wireless communication unit such as Bluetooth or zigbee. The control unit 358 is used to control the driving circuit 351, the temperature detection unit 354, the mode detection unit 355, the current detection unit 356, and the communication unit 357 to work. In this embodiment, the control unit 358 is an arithmetic processing device such as a central processing unit (CPU) or a micro processing unit (MPU), and a storage device such as a random access memory (RAM) or a read only memory (ROM).

FIG. 23 shows a working flowchart of the adapter 3100 of the disclosure. When using the adapter 3100 of the disclosure, the control unit 358 is first awakened by pressing a button, and then the self-locking unit 352 is powered on and self-locked. Next, the mode detection unit 355 detects the working mode, the temperature detection unit 354 detects the temperature of the coil 361, and the communication unit 357 communicates with a first peripheral device and a second peripheral device to obtain status information of the first peripheral device and the second peripheral. When the temperature of the coil 361, or the status information of the first peripheral device or the second peripheral device is abnormal, the control unit 358 will control the corresponding status indicator 353 to flash according to the working mode, switches Q1, K3, K4 or switches Q2, K1, K2 will be turned off, and finally the self-locking unit 352 will release self-locking. The control unit 358 will be powered off. When the temperature of the coil 361, and the status information of the first peripheral device and the second peripheral device are normal, the control unit 358 will set a timer T, and control the corresponding status indicator 353 to be normally turned on according to the working mode. Then, the switches Q1, K3, K4 or the switches Q2, K1, K2 are turned on to make the discharging assembly 330 or the charging assembly 340 work. Next, the current detection unit 356 detects a current of the coil 361, and determines whether the current value is within a preset interval [N1, N2]. If the current value is within the preset interval, the control unit 358 will cancel the timer T. If the current value is greater than N2, the control unit 358 will disconnect the discharging assembly 320 or the charging assembly 330 according to the working mode, then the self-locking unit 352 will be unlocked, and the control unit 358 will be powered off. When the current value is less than N1, the control unit 358 will determine whether the timer T exceeds a preset time. When the timer T exceeds the preset time T, it indicates that the adapter 3100 is not connected with the first peripheral device and the second peripheral device at the same time to discharge or charge.

Compared with the conventional art, the adapter 3100 of the disclosure allows peripheral devices plugged into the adapter 3100 to receive electrical energy or output electrical energy to outside in a non-contact manner through the discharging assembly 320, the charging assembly 330, and the electrical interface 340. This solves the problem that the conventional battery packs, power tools, etc. cannot receive or output electrical energy in a non-contact manner, thereby solving the compatibility problem between electric tools equipped with the wireless power receiving module and old battery packs, and the compatibility problem between battery packs equipped with the wireless power transmitting module and old electric tools.

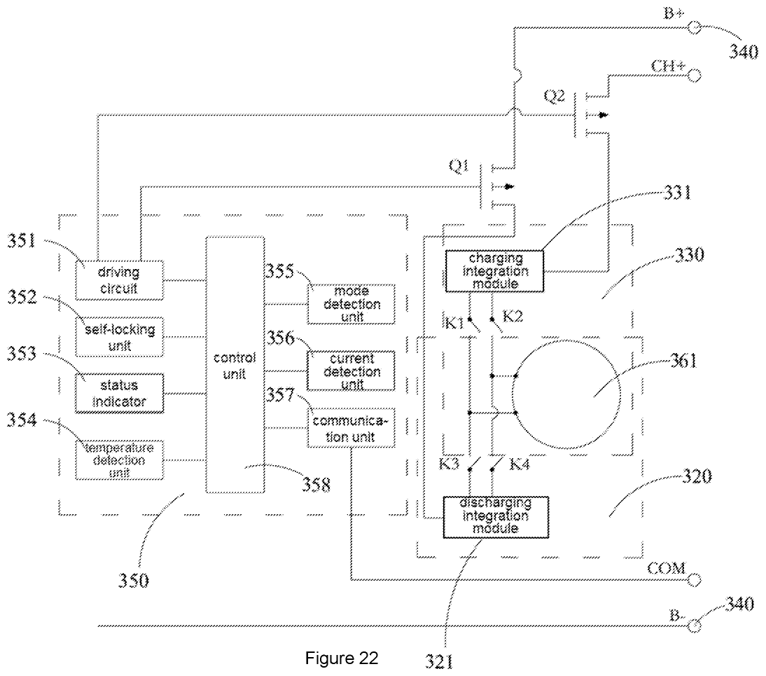

Please refer to FIG. 21. The disclosure also provides an electric tool system 3200, which includes an electric tool 3210, a battery pack 3220, and the adapter 3100. The electric tool 3210 is provided with a power receiving coil (not shown) and an electrical energy conversion circuit (not shown) matched with the power receiving coil. An input end of the electrical energy conversion circuit is connected with the power receiving coil, and an output end thereof is connected with a motor of the electric tool 3210 to supply power to the electric tool 3210. The battery pack 3220 is provided with a connecting interface (not shown). The electrical interface 340 of the adapter 3100 is connected with the connecting interface to obtain power of the battery pack 3220. The coil 361 of the adapter 3100 is coupled with the power receiving coil to output electrical energy to the electric tool 3210. The electric tool 3210 may be a blower, an electric saw, a cutting saw, a vacuum cleaner, a mower, a hedge trimmer, a string trimmer, a drill, etc., or a battery pack provided with a power receiving coil.

In this embodiment, the discharging assembly 320 and the charging assembly 330 of the adapter 3100 share the coil 361. However, in other embodiments, the discharging assembly 320 and the charging assembly 330 may be configured not to share the coil 361, which means that the discharging assembly 320 has a separate discharging coil and the charging assembly 330 has a separate charging coil.

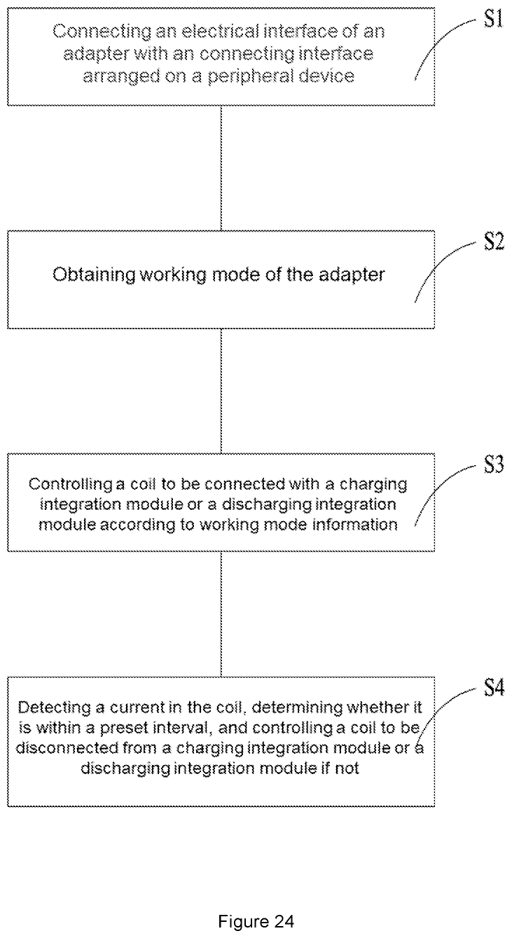

Please refer to FIG. 24. The disclosure also provides a method for using the adapter 3100, the method includes the following operations:

S1: connecting the electrical interface 340 of the adapter 3100 with the connecting interface arranged on the peripheral device.

S2: obtaining working mode of the adapter 3100.

S3: controlling the coil 361 to be connected with the charging integration module 331 or the discharging integration module 321 according to working mode information.

S4: detecting a current in the coil 361, and determining whether the current is within a preset interval; if not, the coil 361 will be controlled to be disconnected from the charging integration module 331 or the discharging integration module 321. Preferably, after the controlling assembly 350 is powered on, determining whether the current of the coil 361 in the time T is always less than a minimum value of the preset interval; if yes, controlling the coil 361 to cut off the charging integration module 331 or cut off the discharging integration module 321, or controlling the controlling assembly to be powered off.

Preferably, the operation S1 further includes the following operations:

S11: obtaining status information of the battery assembly through communicating of the communication unit 357 with the peripheral communication module arranged on the battery pack and determining whether the status information is abnormal. If abnormal, controlling the charging integration module 331 or the discharging integration module 321 to be disconnected from the coil 361.

S12: detecting whether the temperature of the coil 361 is abnormal. If abnormal, controlling the coil 361 to be disconnected from the charging integration module 331 or the discharging integration module 321.

Preferably, the operation S3 further includes the following operations:

S31: determining whether the working mode is the charging mode. If yes, connecting the control coil 361 with the charging integration module 331.

S31: determining whether the working mode is the discharging mode. If yes, connecting the control coil 361 with the discharging integration module 331.

The above embodiments are only used to illustrate the technical solutions of the disclosure and not to limit them. Although the disclosure has been described in detail with reference to preferred embodiments, those of ordinary skill in the art should understand that the technical solutions of the disclosure can be modified or equivalently replaced without departing from the spirit and scope of the technical solutions of the disclosure.

What is claimed is:

1. A battery pack, comprising:
a battery assembly,
a charging assembly, matched with the battery assembly to charge the battery assembly by an external power source, and
a discharging assembly, matched with the battery assembly to supply power to an electric equipment by the battery assembly,
wherein the discharging assembly comprises a discharging coil and a discharging integration module matched with the discharging coil, so that the battery assembly outputs electrical energy through the discharging assembly in a non-contact manner.

2. The battery pack according to claim 1, wherein
the discharging integration module comprises a frequency converter and a converter, an input end of the frequency converter is connected to the battery assembly, an output end of the frequency converter is connected to the discharging coil, an input end of the converter is connected to the battery assembly, and an output end of the converter is connected to the input end of the frequency converter.

3. The battery pack according to claim 1, wherein
the charging assembly comprises a charging coil and a charging integration module matched with the charging coil, so that the battery assembly receives electrical energy in a non-contact manner through the charging assembly, the charging integration module comprises a charging rectifier circuit and a transformer circuit, an input end of the charging rectifier circuit is connected with the charging coil, and an output end of the charging rectifier circuit is connected with the battery assembly, an input end of the transformer circuit is connected with the output end of the charging rectifier circuit, and an output end of the transformer circuit is connected with the battery assembly.

4. The battery pack according to claim 3, wherein
the charging coil and the discharging coil are a coil of a same one or of a same group, the battery pack is also provided with a mode switching button and a status indicator; when the mode switching button is in a first state, the coil matches with the charging integration module; when the mode switching button is in a second state, the coil matches with the discharging integration module; when the battery pack is in a charging mode, the status indicator is in a first state; when the battery pack is in a discharging mode, the status indicator is in a second state.

5. The battery pack according to claim 4, wherein
the battery pack further comprises a housing, the housing comprises a top wall, a bottom wall arranged opposite to the top wall, and a side wall perpendicular to the top wall; the top wall, the bottom wall and the side wall form a receiving cavity to house the battery assembly; at least one of the top wall, the bottom wall, and the side wall is provided with at least one of the coil, an external fixing frame is arranged at a corresponding position of the housing to the coil to assist in fixing the electric equipment.

6. The battery pack according to claim 3, wherein
the battery pack is further provided with a magnetic sheet matched with the charging coil and the discharging coil, and a current detection unit to detect current of the charging assembly or the discharging assembly.

7. A method of using a battery pack, wherein
the battery pack comprises a battery assembly, a charging assembly, and a discharging assembly; the charging assembly comprises a charging coil and a charging integration module matched with the charging coil, so that the battery pack receives electrical energy in a non-contact manner through the charging assembly; the discharging assembly comprises a discharging coil and a discharging integration module matched with the discharging coil, so as to output electrical energy in a non-contact manner through the discharging assembly;
the method of using the battery pack comprises:
detecting status information of the battery pack and determining whether the status information is abnormal,
obtaining a working mode of the battery pack,
controlling the charging coil to be connected to the charging integration module or controlling the discharging coil to be connected to the discharging integration module according to the working mode.

8. The method of using the battery pack according to claim 7, wherein
detecting the status information of the battery pack further comprises:
detecting whether status information of the battery assembly is abnormal and controlling the charging assembly and the discharging assembly to be disconnected from the battery assembly if abnormal,
detecting whether a temperature of the charging coil or the discharging coil is abnormal and controlling the abnormal coil to be disconnected from the corresponding integrated module if abnormal.

9. The method of using the battery pack according to claim 7, wherein
controlling the charging coil to be connected to the charging integration module or
controlling the discharging coil to be connected to the discharging integration module further comprises following operations:
determining whether the working mode is a charging mode; if yes, controlling the charging coil to be connected with the charging integration module;
determining whether working mode is a discharging mode; if yes, controlling the discharging coil to be connected with the discharging integration module.

10. The method of using the battery pack according to claim 7, further comprising:
detecting a current of the charging coil or the discharging coil, determining whether the current is within a preset interval; and if not, controlling the charging coil to be disconnected from the charging integration module, or controlling the discharging coil to be disconnected from the discharging integration module.

11. The method of using the battery pack according to claim 10, wherein
the battery pack further comprises a controlling assembly to control the charging assembly and the discharging assembly,
detecting the current of the charging coil or the discharging coil further comprises: determining whether a current of the charging coil or the discharging coil in a time T is less than a minimum value of a preset interval after the controlling assembly is powered on; and if yes, controlling the charging coil to be disconnected from the charging integration module, or controlling the discharging coil to be disconnected from the discharging integration module, or controlling the controlling assembly to be disconnected from power.

12. A tool system, comprising:
a battery pack of claim 1, and
a power tool, comprising:
a working part, used to perform specific operations, and
amounting part, provided with at least one energy receiving assembly to receive energy wirelessly and transfer received energy to the working part,
wherein the battery pack is mounted in the mounting part, and the discharging assembly matches the energy receiving assembly, so that the battery pack is capable of wirelessly supplying power to the working part.

13. The tool system according to claim 12, wherein
the energy receiving assembly comprises an energy receiving coil and a power rectifier circuit matched with the energy receiving coil; an input end of the power rectifier circuit is connected with the energy receiving coil, an output end of the power rectifier circuit is connected with the working part to supply power to the working part; the discharging assembly further comprises a frequency converter, an input end of the frequency converter is connected with the battery assembly of the battery pack, and an output end of the frequency converter is connected with the discharging coil.

14. A charging system, comprising:
a battery pack of claim 1, and
a charger, comprising:
a charging input, used to be connected with an external power source to obtain power from an external power source, and
an energy transmitting assembly, comprising an energy transmitting coil and an energy transmitting integration module matched with the energy transmitting coil, wherein
one end of the energy transmitting integration module is connected with the charging input, and the other end of the energy transmitting integration module is connected with the energy transmitting coil, so that the power obtained by the charger through the charging input is transmitted to the charging assembly in the battery pack in a non-contact manner through the energy transmitting assembly.

15. The charging system according to claim 14, wherein
the charger is provided with a charging groove to house at least part of the battery pack, the charging groove comprises a groove bottom and a groove wall surrounding the groove bottom, and the energy transmitting coil is arranged on the groove bottom or the groove wall.

16. A tool system, comprising:
a power tool, provided with a power receiving coil and an electrical energy conversion circuit matched with the power receiving coil, wherein
an input end of the electrical energy conversion circuit is connected with the power receiving coil, and an output end of the electrical energy conversion circuit is connected with a motor of the power tool to supply power to the power tool;
a battery pack, provided with a connecting interface; and
an adapter, comprising:
an electrical interface, used to be connected with the connecting interface to obtain electrical energy of the battery pack, and
a discharging assembly, comprising a discharging coil corresponding to the power receiving coil and a discharging integration module matched with the discharging coil, wherein
one end of the discharging integration module is connected with the electrical interface, and the other end of the discharging integration module is connected with the discharging coil, so that the electrical energy of the battery pack obtained by the adapter through the electrical interface is transmitted to the power tool in a non-contact manner through the discharging assembly.

17. The tool system according to claim 16, wherein
the adapter further comprises a charging assembly, the charging assembly comprises a charging coil and a charging integration module matched with the charging coil, one end of the charging integration module is connected with the charging coil, the other end of the charging integration module is connected with the electrical interface, so that the electrical energy received by the adapter through the charging coil is output through the electrical interface, the charging integration module comprises a charging rectifier circuit and a transformer circuit, an input end of the charging rectifier circuit is connected with the charging coil, and an output end of the charging rectifier circuit is connected with an input end of the transformer circuit, and an output end of the transformer circuit is connected with the electrical interface.

18. The tool system according to claim 16, wherein
the adapter further comprises a charging assembly, the charging assembly comprises a charging coil and a charging integration module matched with the charging coil, one end of the charging integration module is connected with the charging coil, the other end of the charging integration module is connected with the electrical interface, so that the electrical energy received by the adapter through the charging coil is output through the electrical interface, the charging integration module comprises a charging rectifier circuit and a transformer circuit, an input end of the charging rectifier circuit is connected with the charging coil, and an output end of the charging rectifier circuit is connected with an input end of the transformer circuit, and an output end of the transformer circuit is connected with the electrical interface.

19. The tool system according to claim 18, wherein
the discharging coil and the charging coil are a same coil, the adapter is further provided with a mode switching button and a status indicator; when the mode switching button is in a first state, the coil matches the discharging integration module; when the mode switching button is in a second state, the coil matches the charging integration module; when the discharging assembly is working, the status indicator is in a first state; and when the charging assembly is working, the status indicator is in a second state.

20. The tool system according to claim 19, wherein
the adapter further comprises a housing, the housing comprises a top wall, a bottom wall, and a side wall between the top wall and the bottom wall; the top wall, the bottom wall and the side wall form a receiving cavity to house the discharging assembly and the charging assembly; at least one of the top wall, the bottom wall, and the side wall is provided with at least one of the charging coil or the discharging coil; an external fixing frame is arranged at a corresponding position of the housing to the discharging coil to assist in fixing the electric equipment; and the adapter is further provided with a current detection unit to detect a current of the charging assembly or the discharging assembly.
